(19) United States
(12) Patent Application Publication
(10) Pub. No.: US 2023/0293270 A1
(43) Pub. Date: Sep. 21, 2023

(54) METHOD AND APPARATUS FOR DENTAL PROSTHETICS

(71) Applicant: Digital Ape Dental Lab, LLC, Southlake, TX (US)

(72) Inventors: Matthew Donald Ross, Prosper, TX (US); Robert Elisha Stapp, JR., Fort Worth, TX (US)

(73) Assignee: Digital Ape Dental Lab, LLC, Southlake, TX (US)

(21) Appl. No.: 18/187,538

(22) Filed: Mar. 21, 2023

Related U.S. Application Data
(60) Provisional application No. 63/269,643, filed on Mar. 21, 2022.

(51) Int. Cl. A61C 8/00; A61C 9/00

(52) U.S. Cl. CPC A61C 8/0089; A61C 8/0095; A61C 9/0053

(57) ABSTRACT

The disclosure presents a system, apparatus, and method for the creation of an accurate a repeatable dental prosthetic appliance. The system and method may be used to create prosthetics either the mandibular arch, the maxillary arch, or both. The system may include one or more of a bone reduction guide, a connectable tooth cap, an abutment guide, a scan bar, and scan bodies for use in photogrammetry record collection. The method includes installing the bone reduction guide to define an area of bone matter to remove from one or both dental arches, placing implants for the fixing of a completed dental prosthetic, and using the implants to generate accurate records to the creation of a merged computer storable record for the repeatable manufacture of dental prosthetics for the patient for whom the record was created.

### CLAIM OF PRIORITY

This application claims priority to U.S. Provisional Patent Application 63/269,643 filed on Mar. 21, 2022.

### BACKGROUND

### Field of the Disclosure

This disclosure relates to a method and apparatus for utilizing photogrammetry and clinical records to create a more accurate and repeatable fabrication of dental prosthetics

### Background of the Disclosure

Historically, full-arch dental prosthetics have required a great deal of time and guesswork by a restorative dentist, and often a lengthy period of time during which the patient has to endure the use of temporary dentures until the restorative dentist can make major and minor adjustments to a permanent prosthetic that is both surgically and aesthetically viable. Additionally, much of the restorative work performed by the prosthodontist or restorative dentist is dependent on the results of the extraction and bone removal performed by various dental surgeons or periodontists prior to the prosthodontist being able to hand-shape and determine the proper height, depth, and width of the appropriate dental prosthesis based upon the differences in the amount of bone removal and the lack of consistency from one patient to the next and one surgical procedure to the next.

Virtually all full-arch replacements require that before any prosthetic can be created and fitted, all of the patient's existing teeth must be removed by either a dental surgeon, a periodontist, or a general dentist. Typical records that are collected at the surgical stage include: (1) impressions (either analog or digital) of either the maxillary or mandibular arch, or both, (2) bite registration, and either a CT scan or photographs of the patient's existing bite and arch architecture, which together create the “smile” of the patient. Current methods of fabricating full-arch replacements include forwarding these records to the restorative dentist to allow him/her to begin construction of a model for the eventual prosthesis—often by hand.

The current method is therefore time consuming and often frustrating for the patient based on the amount of time it takes the restorative dentist to complete a handmade model for fitment with the patient, or to create a computer-generated model based solely on the images and impressions provided by the dental surgeon or periodontist.

Recent developments in 3D printing have reduced the amount of time required to complete fabrication of a permanent prosthesis, but the problem of creating an accurate model that would supersede the slow and painstaking process of fabrication of the original patient model and fitment remain.

### SUMMARY OF THE INVENTION

In one embodiment, the present disclosure may include a guide system for facilitating the manufacture of temporary or permanent prostheses for both arches—mandibular and maxillary—of a patient. The system in accordance with this embodiment, may include maxillary and mandibular bone reduction guides, maxillary and mandibular abutment guides, bone screws, guide pins, one or more optional bone reduction extenders, one or more optional implant placement guides, abutments, a maxillary scan bar, and a pickup device, and scan bodies.

In another embodiment, the guide system may include the disclosed components to facilitate the manufacture of temporary or permanent maxillary arch prostheses. This system in accordance with this embodiment, may include a maxillary bone reduction guide, a maxillary abutment guide, bone screws, guide pins, an optional bone reduction extenders, an implant placement guide, abutments, a maxillary scan bar, a pickup device, and scan bodies.

In yet another embodiment, the guide system may include the disclosed components to facilitate the manufacture of temporary or permanent mandibular arch prostheses. This system in accordance with this embodiment, may include a mandibular bone reduction guide, a mandibular abutment guide, bone screws, guide pins, an optional bone reduction extenders, an implant placement guide, abutments, a pickup device, and scan bodies.

In yet another embodiment, a method is disclosed that provides a time- and resource-efficient manner of designing and producing temporary and permanent prostheses for the maxillary arch, the mandibular arch, or both maxillary and mandibular arches. The method provides the steps necessary for employing various components of the guide system to facilitate a dental care provider with the necessary tools and system components to accurately perform bone reduction, implanted abutment placement, intraoral scanning of the patient for proper placement of prostheses, and photogrammetry. The combination of the use of a guide system as disclosed herein, together with digitized files representing the proper placement of abutments, the proper alignment of model abutment guides provides the necessary information for the 3D printing of temporary or permanent dental prostheses that are both accurate and repeatable.

### BRIEF DESCRIPTION OF THE DRAWINGS

FIG. 1 illustrates a perspective view of a mandibular bone reduction guide in accordance with the principles of the present disclosure;

FIG. 2 illustrates a perspective view of a mandibular tooth mount in accordance with the principles of the present disclosure;

FIGS. 3A-3D illustrate views of the stages of affixing the mandibular bone reduction guide using mandibular tooth mount installed in the bone reduction guide in accordance with the principles of the present disclosure;

FIG. 4 illustrates a bone reduction guide extender guide in accordance with the principles of the present disclosure;

FIG. 5 illustrates a bone reduction guide mounted on a mandible after bone matter has been removed in accordance with the bone reduction guide in accordance with the principles of the present disclosure;

FIGS. 6A-6C illustrate views of an abutment guide for mandibular arch replacement guide in accordance with the principles of the present disclosure;

FIGS. 7A-7B illustrate examples of placement of implants in a bone-reduced mandible in accordance with the principles of the present disclosure;

FIG. 8A illustrates a mandibular implant placement guide for the placement of implants in accordance with the principles of the present disclosure;

FIG. 8B illustrates a perspective view of an implant placement guide in accordance with the principles of the present disclosure;

FIG. 9 illustrates a robotic dental device for use in placing implants in the bone-reduced mandible and/or bone-reduced maxillary arch;

FIG. 10 illustrates soft tissue healing caps installed in implants placed in the mandible of a patient in accordance with the principles of the present disclosure;

FIG. 11A illustrates a perspective view of a maxillary bone reduction guide in accordance with the principles of the present disclosure;

FIG. 11B illustrates a maxillary bone reduction guide mounted to the piriform rim in accordance with the principles of the present disclosure;

FIG. 12A illustrates a view of a maxillary tooth mount in accordance with the principles of the present disclosure;

FIG. 12B illustrates a view of a maxillary tooth mount pinned to a maxillary bone reduction guide in accordance with the principles of the present disclosure;

FIG. 12C illustrates a view of a maxillary tooth mount pinned to a maxillary bone reduction guide that is affixed to the maxillary arch using bone screws in accordance with the principles of the present disclosure;

FIG. 12D illustrates a view of a bone reduction guide affixed to the maxillary arch after the maxillary tooth mount is removed in accordance with the principles of the present disclosure;

FIG. 13A illustrates a perspective view of a scan bar in accordance with the principles of the present disclosure;

FIG. 13B illustrates a scan bar affixed to a maxillary bone reduction guide in accordance with the principles of the present disclosure;

FIG. 14A illustrates implants in the maxillary arch in accordance with the principles of the present disclosure;

FIG. 14B illustrates the installation and measurement of implants in the maxillary arch in accordance with the principles of the present disclosure;

FIG. 14C illustrates an example of a maxillary implant guide affixed to an affixed maxillary bone reduction guide in accordance with the principles of the present disclosure;

FIG. 14D illustrates a perspective view of a maxillary abutment guide affixed to a maxillary bone reduction guide in accordance with the principles of the present disclosure;

FIG. 15 illustrates a scan bar affixed to a maxillary bone reduction guide in accordance with the principles of the present disclosure;

FIG. 16 illustrates an abutment guide affixed to the bone reduction guide with implants in accordance with the principles of the present disclosure;

FIGS. 17A-17D illustrate scan bodies affixed to the scan bar and the maxillary arch in accordance with the principles of the present disclosure;

FIG. 18 illustrates a maxillary pickup device in accordance with the principles of the present disclosure;

FIG. 19 illustrates the engagement of a maxillary abutment guide with an affixed maxillary bone reduction guide in accordance with the principles of the present disclosure;

FIGS. 20A-20B illustrates proper alignment of a maxillary pickup device with an affixed maxillary bone reduction guide in accordance with the principles of the present disclosure;

FIGS. 21A-21B illustrates the alignment of the mandible pick up device with the maxillary pick up device in accordance with the principles of the present disclosure;

FIG. 22 illustrates an example of an impression of an arch that demonstrates the relative positions of the implants and soft tissue healing caps after proper occlusion is achieved in accordance with the principles of the present disclosure;

FIG. 23 illustrates scan bodies affixed to implants in the mandible in accordance with principles of the present disclosure;

FIGS. 24A-24C illustrate an example of a final intraoral scan of a model mandible arch in occlusion with a maxillary pickup device including an impression of the maxillary arch with implants and soft tissue healing caps in accordance with the principles of the present disclosure.

### DETAILED DESCRIPTION OF THE INVENTION

The preferred versions of the disclosure presented in the following written description and the various features and advantageous details thereof, are explained more fully with reference to the non-limiting examples included in the accompanying drawings and as detailed in the description, which follows. Descriptions of well-known components have been omitted so to not unnecessarily obscure the principle features described herein. The examples used in the following description are intended to facilitate an understanding of the ways in which the disclosure can be implemented and practiced. Accordingly, these examples should not be construed as limiting the scope of the claims.

### Record Collection

Preparation of dental prostheses is often a long, costly, and tedious endeavor. It often requires a restorative dentist (prosthodontist) to spend an enormous amount of time hand-fitting dental prostheses to each specific patient after the patient has undergone dental surgery to remove the teeth and enough bone matter to allow for the permanent fixation of the prostheses into implants installed in the patient's maxillary arch and mandible. The basic system is designed to capture the six prosthetic records in digital form to both aid the dental surgeon in bone reduction and to provide a comprehensive merged record that will allow for efficient manufacture of a dental prosthetic using 3-Dimensional (3D) printing technology.

The collection of data for the digitization of the patient's records begins at the preliminary clinical examination stage. At the clinical examination stage, the surgeon will collect at least the following restorative records: impressions of the maxillary arch and mandibular arch, bite registration using centric relation, centric occlusion, or other suitable methods as are known in the art; and lab script. While it is preferable for all records to be recorded in digital form, analog records are acceptable from the restorative exam. The restorative clinical examination may also generate photographic or video records of the patient, or other records if necessary. If the patient's occlusion is considered Class II (overbite), this information should be specifically collected and noted. In addition, at least the following surgical clinical records should be collected: a dental cone beam CT scan (CBCT Scan), a new case record, and a plan approval, which should include a bone reduction plan, and may also include a recommendation regarding guided or robotic surgery. The CBCT scan or other suitable scan to produce an accurate 3D image of the patients arches is important, because the generated three dimensional (3-D) images include dental structures, soft tissues, nerve paths and bone in the all of the affected areas of a patient's craniofacial structure.

### Virtual Guide System Design

Once the clinical examination is complete, the dental surgeon and restorative dentist (if different practitioners) forward the patient's collected records to a fabrication laboratory for the creation of the fabrication laboratory. If the records are analog, the laboratory should convert the records to digital records. Once all clinical records are in digital format, the laboratory uses the CBCT scan or other 3D imagery of the patient's craniofacial features, and creates a proposed “smile” for the patient. That is, the laboratory generates a proposed virtual rendering of the patient's arches with all teeth restored. Preferably, the virtual smile created will retain and maintain key elements of the patient's pre-prosthetic smile, such that problems with centric relation, vertical dimension, esthetics, occlusion, implant position for accuracy of fit and comfort. Important factors to consider when creating the patient's virtual smile with respect to the maxillary arch include, but are not limited to central incisor mold (size, shape) and position, arch form, and occlusal plane. Smile factors to consider when creating the virtual smile with respect to the mandibular arch include, but are not limited to occlusal relationship (bite, contact, overjet/bite, underbite), and vertical dimension. Several software programs exist to assist in the creation of the patient's virtual smile. One example is Straumann's CoDiagnostix software.

After the virtual smile is complete, the next phase includes virtual bone reduction planning. Generally, bone reduction in adult patients is recommended to be approximately 15 mm from the ideal incisal edge position (determined when creating the virtual smile) for both maxillary and mandibular arches. Additionally, if requested by the surgeon, the laboratory may provide virtual placement planning, including but not limited to anterior/posterior spread (“AP Spread”), bone thickness, and/or anatomical landmarks, such as sinuses, nerves, and any aberrations of the piriform floor.

Another step in the virtual guide system design is the selection and placement of virtual abutments. The abutments may provide the location for ideal access locations for the eventual prosthetics. The “access locations” comprise one or more ports or holes in the prosthetic that permit a connector, such as a bolt, screw, or post, to be inserted through the prosthetic and into the appropriate arch (maxillary or mandibular) to secure the prosthetic to the patient, either temporarily or permanently. The optimal or preferable planning for the access locations may be conducted at the virtual smile creation, or thereafter, using the clinical data such as photographs, CBCT Scan, or other medical records, such as surgical, injury, or disease or infection history.

Another step in the virtual guide system design includes designing the virtual surgical guide system that, when completed, will be used to create the physical components of the surgical guide system. The individual components that are designed include, for one or both arches: a bone reduction guide and tooth mount, a scan bar, an abutment guide, a pick up guide, and a CR (centric relation) jig. Additionally, if requested by the surgeon, an implant placement guide and bone reduction guide extender may be designed. Each of these components will be described in greater detail below during the description of the surgical and prosthetic manufacturing processes.

### Surgical Guide System Fabrication

Once the virtual surgical guide system design is complete, manufacture of the individual components of the system may be fabricated. Due to the advent and ubiquity of 3D printers, the laboratory may use the files created for the patient to create a series of files based on the virtual guide design to print each component for the patient based on the patient's craniofacial anatomy. Typical materials for fabrication of the physical components of the surgical guide system include polymers, nylon, plastics, and other suitable 3D printer materials as are known in the art.

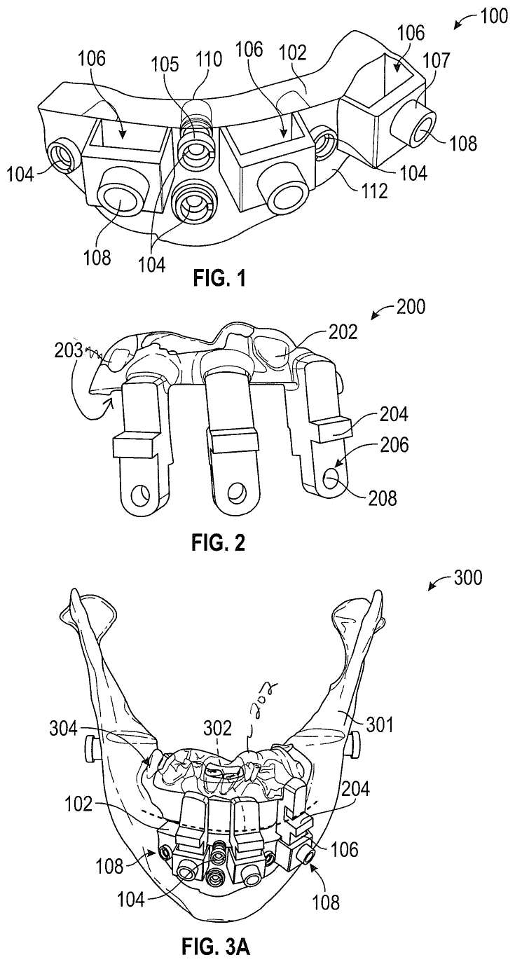

The following parts comprise the core of the surgical guide system. While some parts must be installed in a specific sequence, there is no requirement that the individual components be manufactured in any specific order. The first component disclosed is the mandibular bone reduction guide 100, an example of which is shown in FIG. 1. The mandibular bone reduction guide 100 includes a guide edge 102, bone connection apertures 104, tooth cap connectors 106, an inner face 110, and an outer face 112. The guide edge 102 is preferably substantially planar to facilitate the reduction of bone material from the mandible evenly, but may have varied topography based on the bone reduction requested by the surgeon in some cases. The guide edge 102 forms the line to which the surgeon will remove the bone once the teeth have been extracted, as discussed further below. The bone connection apertures 104 may be reinforced with a grommet or sleeve 105. The bone connection apertures provide a pre-designed location determined during the virtual design phase discuss above that is preferably optimized for the connection of the bone reduction guide 100 to the mandible of the patient during surgery. The bone reduction guide 100 also includes a tooth mount connection 106 for facilitating the connection of the tooth mount 200 described below with respect to FIG. 2. In the embodiment shown, the tooth mount connection 106 includes a guide aperture 107 for receiving a tab or other geometrically compatible protrusion of the tooth mount 200. In the embodiment shown, tooth mount connection 106 further includes a pin aperture 108, which is operable to receive a pin, screw, or other suitable connector to hold the tooth mount 200 in place when its protrusion or tab is inserted into the tooth mount connection 106. While the topography of outer face 112 is only constrained by the ability to house an appropriate connection between bone reduction guide 100 and tooth mount 200, inner face 110 is generally concave and preferably designed and manufactured such that it fits the contours of the patient's mandible when it is positioned appropriately. In most cases, the inner face 110 of the bone guide 100 extends from canine to canine on the mandible, but may end further anterior or extend further posterior, depending on the preference of the surgeon and or prosthodontist.

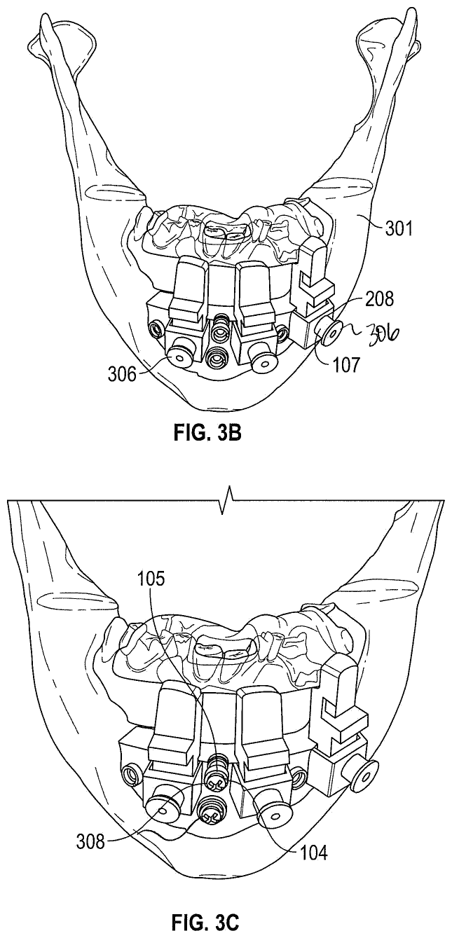

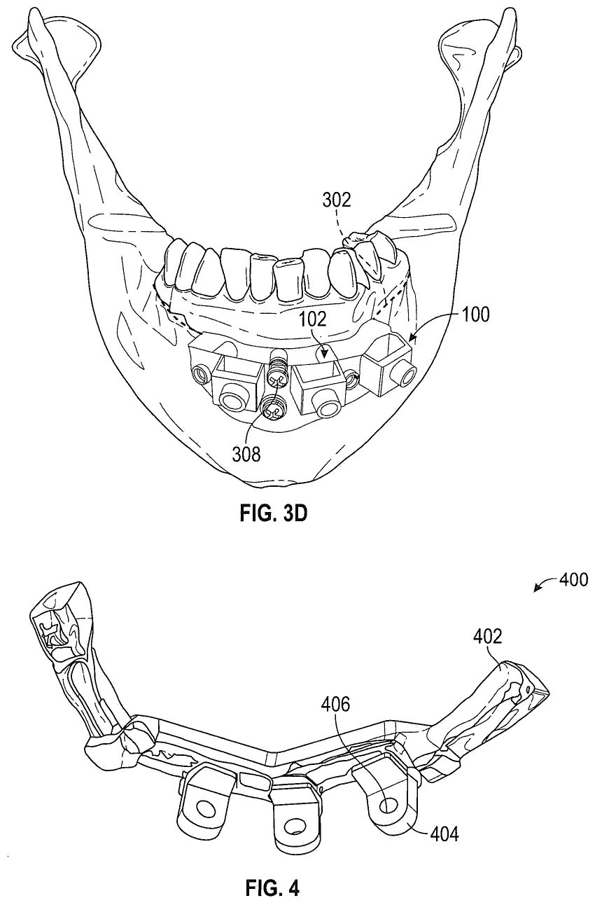

FIG. 2 shows an embodiment of the tooth mount 200 that includes an outer surface 202 and an inner surface 203. The inner surface 203 is preferably configured to fit over the patient's lower front teeth such that one or more protrusions or tabs 206 are facing downward. A connection aperture 208 is preferably configured in one or more of tabs 206 such that when the tab 206 is properly inserted into the tooth mount connection 106 of the bone reduction guide 100 the connection aperture 208 is aligned with the guide aperture 107 of the tooth mount connection 106 of bone reduction guide 100. Preferably the tooth mount 200 is configured such that when inner surface 203 is in proper contact with a patient's teeth, one or more tabs 206 are inserted into tooth mount connection 106 of bone reduction guide 100 such that aperture or apertures 107 are aligned with one or more tooth mount apertures 208, a pin inserted through both apertures 107, 208 will position the bone reduction guide 100 at the designed location for bone removal as shown in FIG. 3. A lip or tab shelf 207 may be included as part of tab 206 to prevent the tab 206 from inserting too far into the aperture 107 of tooth mount connection 106. While the present embodiment uses tabs 206, slots 104, and pins to connect the bone connection guide 100 and the tooth mount 200, other connections may be used, such as, for example magnets, a rod and cup connection, a quick-connect, or other suitable connection.

FIG. 3A shows an embodiment of the bone reduction guide 100 and tooth mount 200 that are connected as a system 300 on a mandible 301. The cap portion 202 of tooth mount 200 rests on teeth 304, and the bone reduction guide 100 is connected such that its upper surface 102 creates a reduction line 302 adjacent to the upper surface 102 that represents the proper amount of mandible bone matter for the surgeon to remove according to the surgical guide system.

In FIG. 3B, a pin or pins 306 is inserted through tooth mount aperture 208 and guide aperture 107 to secure the bone reduction guide 100 in place in relation to the mandible 301, and the tooth mount 200.

Once the surgeon is satisfied with the placement of the bone reduction guide 100, he or she may use a suitable connection to fix the bone reduction guide 100 to the mandible 301. In the embodiment shown in FIG. 3C, bone screws 308 are used to fix the bone reduction guide 100 to the mandible 301 by inserting them through bone screw slot 104, and optionally through reinforcing sleeve 105 to secure the bone reduction guide 100 to the mandible 301. As shown in FIG. 3D, once the bone reduction guide 100 is secured to the mandible 301, the system 300 may be disassembled by removing pins 306, and removing the tooth mount 200 from its connection to bone reduction guide 100. The bone reduction guide 100 remains secured to the mandible 301 by screws 308.

In addition to bone reduction guide 100, a bone reduction guide extender 400, as shown in FIG. 4, may be attached to bone reduction guide 100 to extend a bone reduction surface 402 and therefore bone reduction line 302 (shown in FIGS. 3A and 3D) posterior to the guide surface 102 of bone reduction guide 100.

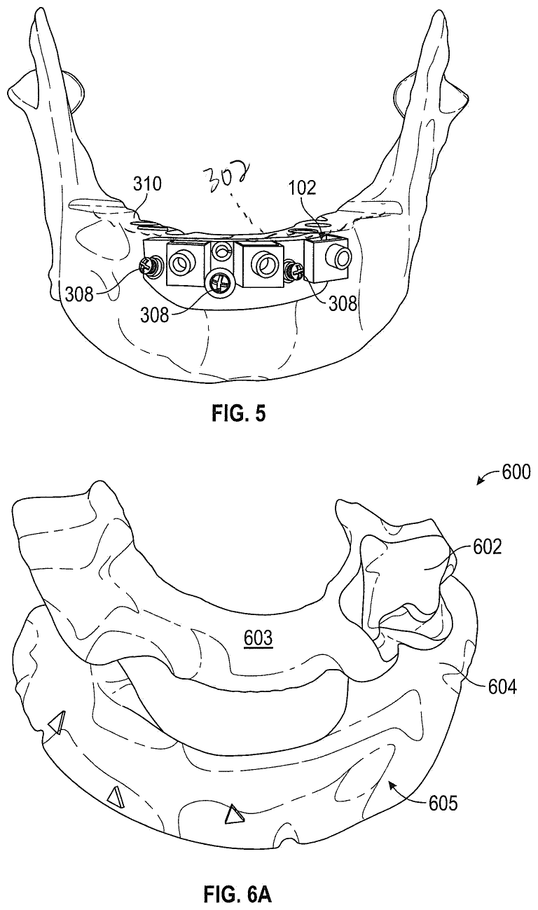

For ease of understanding, FIG. 5 illustrates a mandible 301 that has had bone material removed in accordance with the bone reduction guide 100 along the reduction line 302 in preparation for receiving implant. The result is mandibular mounting surface 310, which is the area used for placing the implants that will eventually be used to receive the connectors that will secure the prosthesis to the mandibular mounting surface 310.

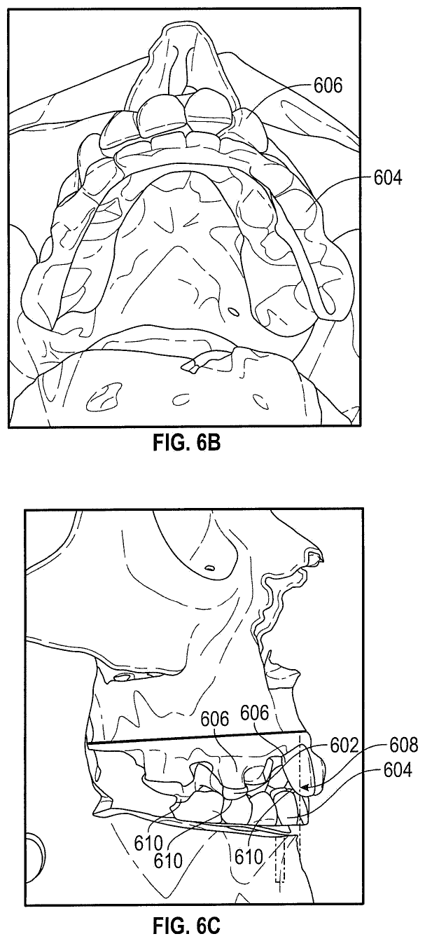

Another component of the surgical guide system is the mandibular abutment guide 600, shown in FIG. 6A. Mandibular abutment guide 600 includes at least a mandibular device 604 that approximates the shapes, angles and design of the teeth 605 of the mandibular portion of the virtual smile created during the virtual design phase. The mandibular abutment guide 600 may also include a maxillary cap 602 that fits over existing maxillary teeth to provide visual assistance to the surgeon. The purpose of the mandibular abutment guide is to determine proper abutment angle of the mandibular arch prosthesis relative to the maxillary arch, as well as the access aperture positions of the mandibular prostheses.

FIG. 6B shows the mandibular abutment device 604 placed in abutment with the maxillary teeth 606 to attempt to achieve the appropriate fit. In FIG. 6C maxillary cap 602 is placed over the contact surfaces of the maxillary teeth 606, and the mandibular abutment device 604 is manipulated by the surgeon to achieve proper centric relation 608, and occlusion 610 to determine the appropriate location of the access holes in the eventual prosthesis.

The placement of implants may be accomplished in multiple ways, including free hand, using a implant placement guide and drilling the implant sockets in the bone by hand through the guide's pilot holes, or using a dental robot and implant placement guide, such as the robot shown in FIG. 9.

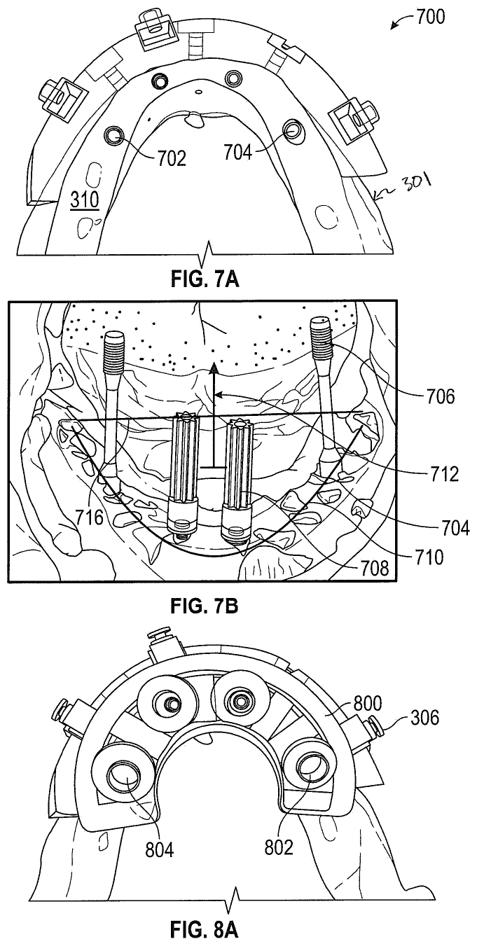

FIG. 7A illustrates implants 702 placed by drilling using the freehand method into bone sockets 704 created in the mandibular mounting surface 310 of mandible 301. In this embodiment, the implants 702 are secured in sockets 704 using pharmaceutical grade bone epoxy, but other suitable adhesives, glues, or anchors may be used. Implants 702 are preferably threaded, so that scan bodies, soft tissue healing caps, and (eventually) a prosthesis may be secured to mandible 301 by screwing the various appliances into the implants 702.

FIG. 7B illustrates placement of implants 702 using implant placement tools 706. Implant covers and/or placement guides 708 may be used to place and protect implants 702 from moisture, including saliva and blood, to allow the epoxy or other suitable glue or adhesive to set in a protected environment, as well as to manipulate the implant to the proper orientation. Regardless of the method used to place the implants 702, it is preferable to make note of measurements for AP spread 710, distal extension 712, and any other measurements necessary to ensure proper fitment of the prosthesis.

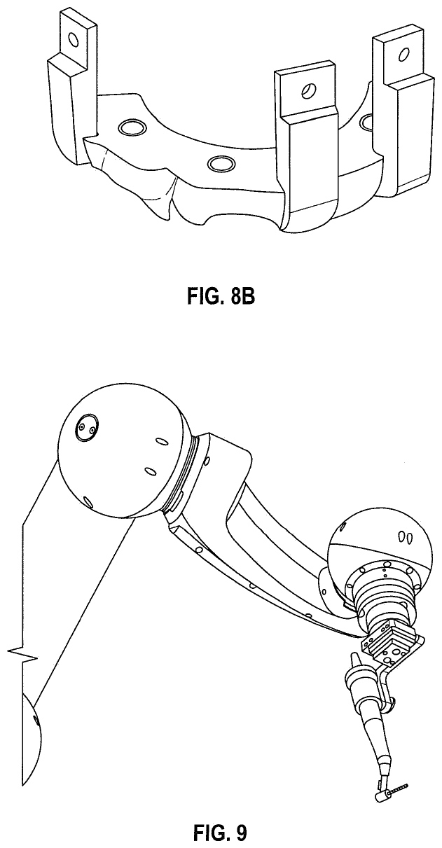

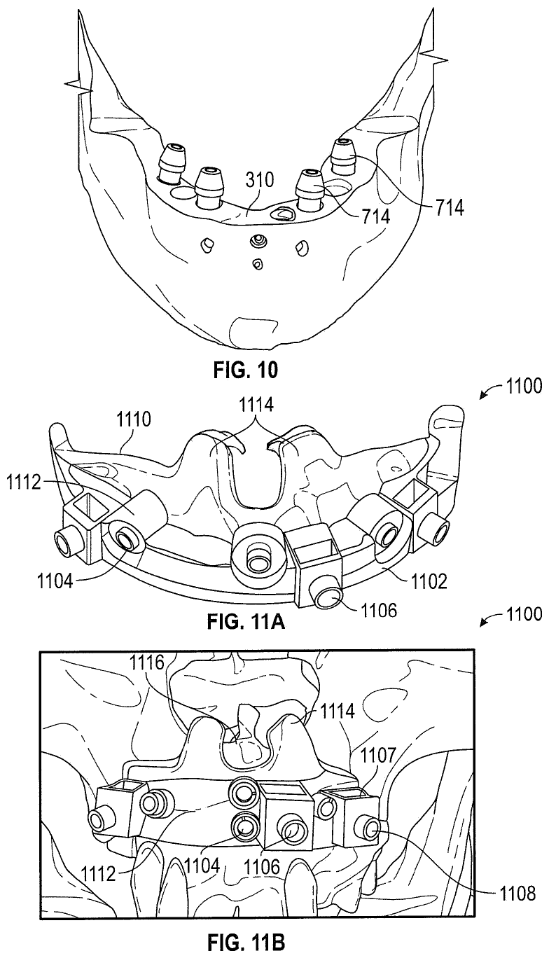

FIGS. 8A-8B illustrate an implant placement guide 800. The implant placement guide 800 includes pilot holes 802, which preferably include grommets or sleeves 804. The sleeves 804 are preferably made of a metal or other material that is sufficiently hard to maintain the correct orientation and angle for the pilot holes 802, so that during drilling the of the implant sockets the location and orientation of the drill remains consistent, and is not altered due to damage caused to the polymer or nylon material typically used for the placement guide 800.

In addition to using an implant placement guide 800 for freehand drilling of the implant sockets in the mandibular mounting surface 310, a robot such as the YOMI robot shown in FIG. 9 may be used. An advantage to using a robot for drilling is the precision with which dental robot 900 can drill, including direction, location, and proper depth.

After the implants 702 are set in the mandible 301, soft tissue healing caps 714 should be inserted and tightened to hand-tight in each insert 702 to prevent ingress of soft tissue. Once the soft tissue healing caps are installed, the soft tissue may be closed using appropriate suturing techniques, ensuring that excess soft tissue is removed around the healing caps 714 to permit healing and to provide future access to the implants.

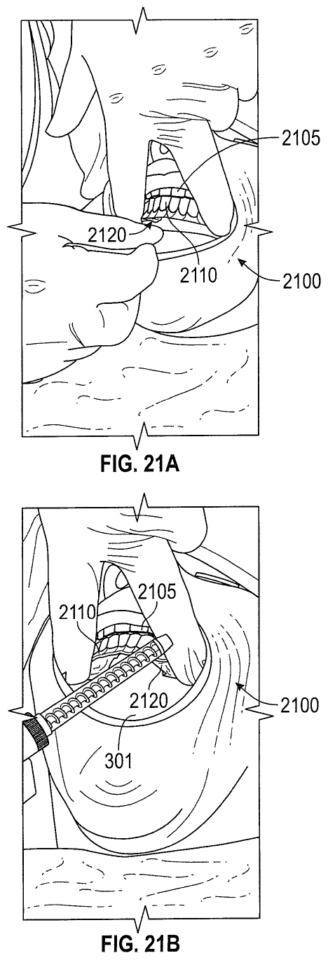

If the patient is only receiving a mandibular arch, the next step is to use a pickup guide system 2100 as shown in FIGS. 21A-21B to facilitate in completing the records required for the final prosthesis. The mandibular pickup guide 2110 is place in relation to maxillary teeth 2105. Typically, the surgeon will adjust the mandible 301 and the mandibular pickup guide 2110 until centric relation, vertical dimension, and proper occlusion are obtained. Once the surgeon is satisfied, he or she will fill the intaglio 2120 of the mandibular pickup device with impression material, such as PVC or other suitable impression material, and close the patient's mandible in centric relation with the maxillary arch until the impression material sets. Once it is set, the impression/pickup device assembly 2200 with the pickup device 2110 still attached to the impression 2210 is immediately checked to ensure that the soft tissue healing caps 714 are properly registered by healing cap markers 2220 in impression 2210, along with a good soft tissue impression 2230, and the entire assembly is scanned using an intraoral scanner (not shown). Additionally, the surgeon will remove the soft tissue healing caps 714 and insert scan bodies 2310 into implants 702 as shown in FIG. 23. The surgeon or his technician will then conduct a photogrammetry scan of the mandible 301 with the scan bodies 2310 to capture the orientation of the implants relative to the mandible 301, which is the sixth and final record required for the mandibular arch replacement. At the completion of the photogrammetry scan, all necessary records are collected, including centric relation, vertical dimension, esthetics, occlusion, soft tissue, and with the final photogrammetry scan, implant position.

Once collected, the six records are merged into a single file, and converted for use as a 3D printer file. At this point, the printer may use appropriate 3D polymers, such as PEKK or PEEK, or other suitably durable polymers, to print the prosthetic for the patient.

If the patient is receiving a double arch replacement, after the soft tissue closure of the mandible is complete, the surgeon moves directly to the maxillary surgery. Several of the components of the maxillary surgery are the same as the components of the mandibular surgery, however configured for the anatomy of the patient's maxillary arch.

FIGS. 11A-11B shows the maxillary bone reduction guide 1100 includes the same guide edge 1102 as mandibular guide edge 102, except that the maxillary guide edge 1112 is facing downward and away from the patient's piriform floor 1116. It has the same bone screw slots 1104, sleeves 1105, tooth cap connectors 1106, guide aperture 1107, pin aperture 1108, inner face 1110 and outer face 1112. Additionally, the maxillary bone reduction guide includes piriform floor hooks 1114, which rest on the bone of the patient's piriform floor 1116.

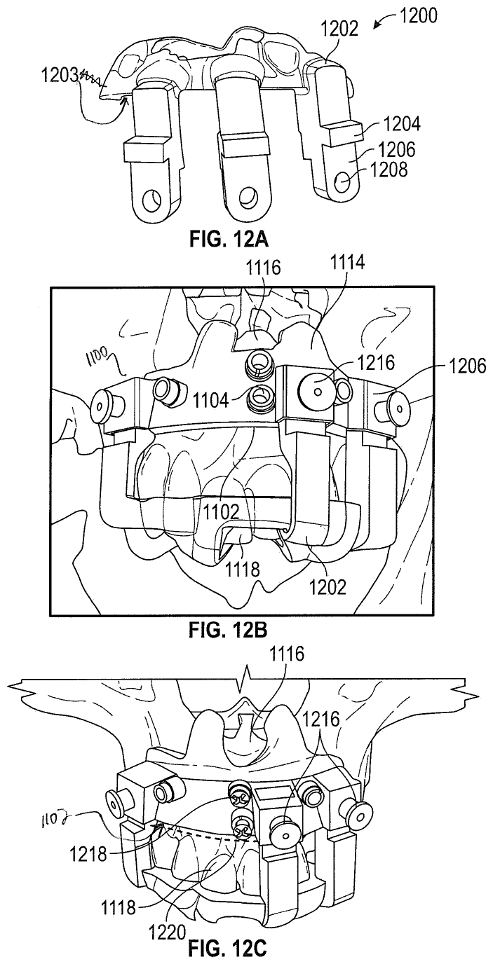

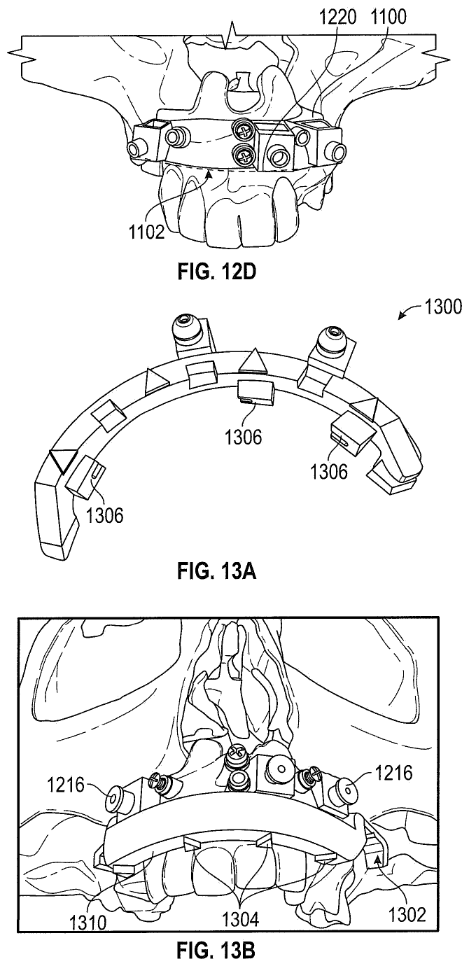

FIG. 12A shows the maxillary tooth cap 1200, which, like the mandibular tooth cap, includes outer surface 1202, inner surface 1203 that is formed to rest on the maxillary teeth, tabs 1206 that include connection aperture 1208.

As shown in FIGS. 12B-12C, the maxillary tooth cap 1200 and bone reduction guide 1100 connect in a similar manner as the embodiment shown in FIGS. 3A-3C with respect to the mandibular bone reduction guide 100 and mandibular tooth cap 200 of FIGS. 1 & 2, except that the maxillary bone reduction guide 1100 includes the piriform floor hooks 1114 which hook to the patient's piriform floor 1116, and the as well as being secured over the incisors and other teeth in the anterior of the maxillary arch 1118, thus creating a more secure fit and stable platform, because during a double arch replacement, the maxillary arch is the reference point for adjustment of centric relation, vertical dimension, and occlusion.

Once the maxillary bone reduction guide 1100 is hooked to the piriform rim 1116 using piriform rim hooks 1114 and the maxillary tooth cap 1200 is connected via pins 1216 (other suitable methods for connection as described above with respect to the mandibular bone reduction guide and mandibular tooth cap are also applicable), and the maxillary bone reduction surface 1102 defines the bone reduction line 1220 for the surgeon, the surgeon may secure the maxillary bone reduction guide 1100 to the maxillary arch using bone screws 1218. Preferably, the screws penetrate the maxillary arch to engage both the facial and lingual cortex for optimal stability, and the preferred orientation of the screws is two vertically-stacked screws in the anterior portion of the arch, and two lateral screws distal to the canine on either side, but the distal screws may be removed it they impede implant placement,

Once the maxillary bone reduction guide 1100 is placed, the maxillary tooth cap may be removed, so that the maxillary bone reduction guide 1100 is the only device installed on the patient, and the surgeon is satisfied by the bone reduction guideline 1220 established by the maxillary guide surface 1102.

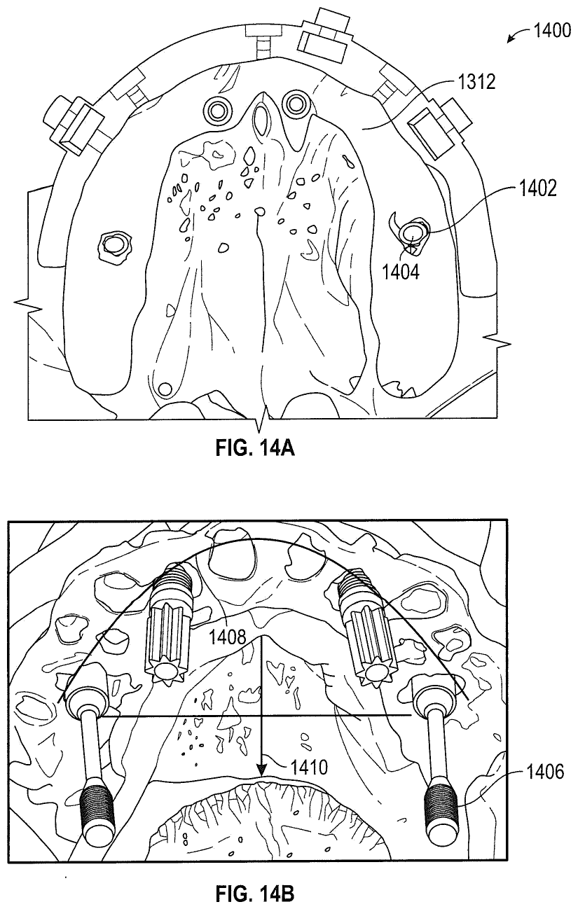

Next, the scan bar 1300, shown in FIGS. 13A-13C is attached to the maxillary bone reduction guide 1100, preferably using the same connection method (tabs 1306 and pins 1216) as the maxillary tooth cap 1200. The scan bar 1300 serves two purposes. First, when attached it serves as a maxillary bone reduction guide extender as shown in FIG. 15, using extended maxillary guide surface 1302. Additionally, the scan bar includes markers 1304 designed to assist with the proper location for implants in the maxillary arch after bone removal. Accordingly, once the scan bar 1300 is attached to the maxillary bone reduction guide 1100, and prior to the extraction of any teeth, the first maxillary intraoral scan is performed, attempting to capture only the relative location of the maxillary teeth 1308 and the scan markers 1304, as shown in FIG. 13C. After a satisfactory scan, the scan bar 1300 may be removed from the maxillary bone reduction guide 1100.

Next, the surgeon performs extraction and bone reduction to the maxillary bone reduction line 1220 indicated by the maxillary guide surface 1102 of the maxillary bone reduction guide 1100. To check the bone reduction, the surgeon may re-attach the scan bar 1300 and use the scan bar extended maxillary guide surface 1302 to check the proper removal of bone matter from the maxillary arch 1310.

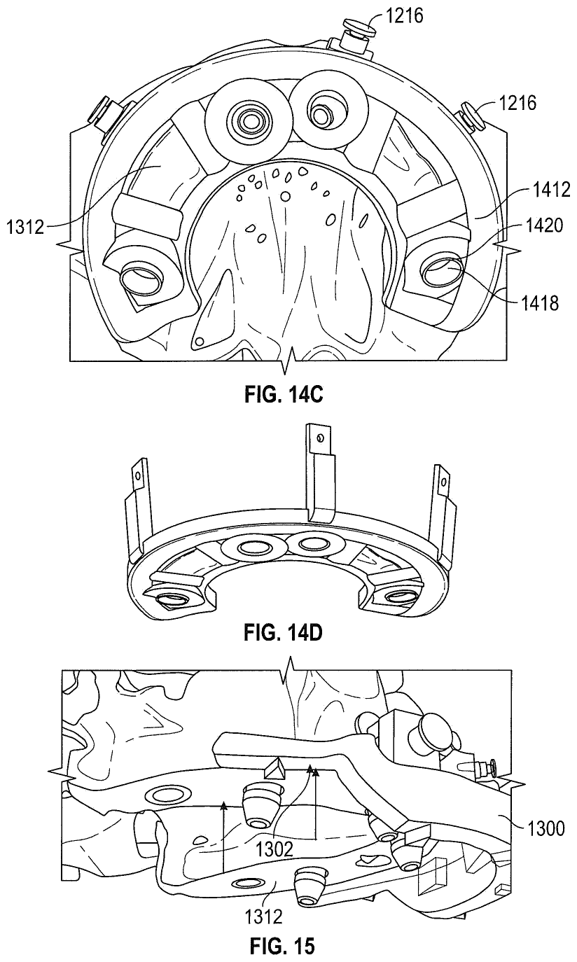

Once complete with maxillary bone reduction, the implants 1402 may be installed by drilling maxillary implant sockets 1404 in the same manner as with the mandible implants 702 —freehand (FIG. 14A), using a maxillary implant guide 1412 having pilot holes 1418 and preferably sleeves 1420 by connecting the maxillary implant guide 1412 to the maxillary bone reduction guide 1100 using the same connection method as with the scan bar 1300 and tooth cap 1200 as shown in FIG. 14C (in this case pins, but other connectors may be used as previously discussed), or using the maxillary implant guide 1412 in conjunction with a dental robot, such as that shown in FIG. 9.

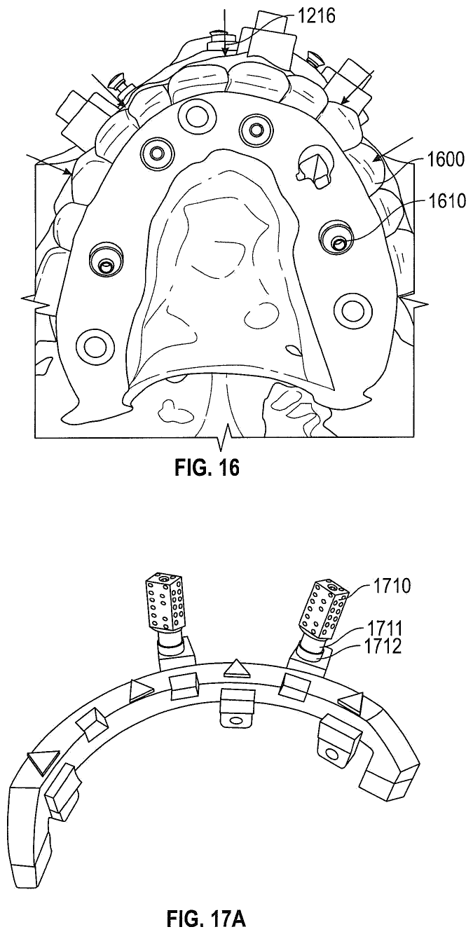

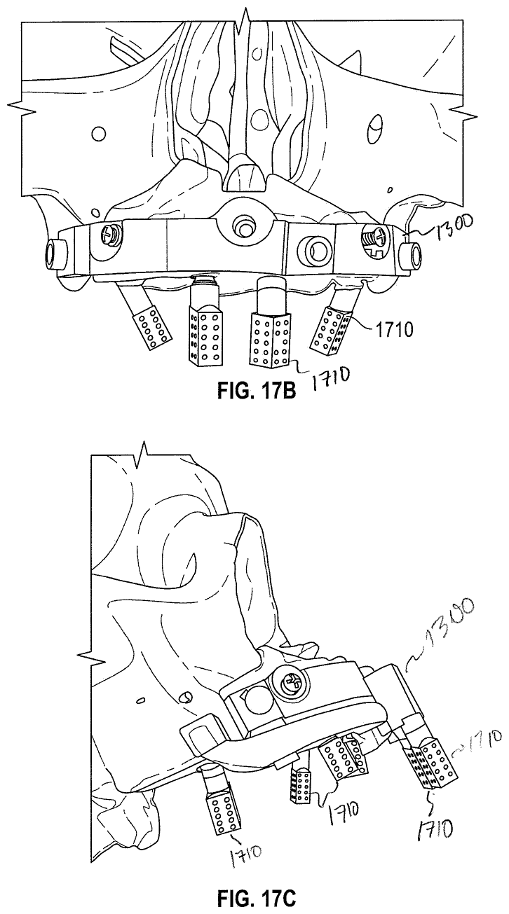

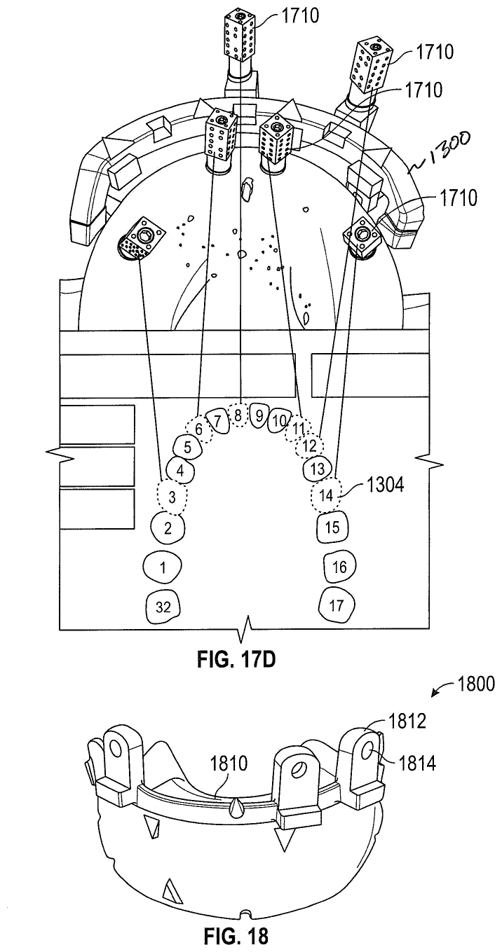

As shown in FIG. 16, after the implants 1402 are set, the surgeon should select maxillary abutments 1610. Factors to consider when selecting the maxillary abutments include choosing the lowest and/or shortest abutment height to minimize potential differences the patient may notice with the prosthetic, ensuring that the angles of the abutments relative to each other as parallel as possible, and the location of the anterior access apertures that will be in the actual prosthetic for mounting to the maxillary arch. When placing the abutments 1610, connect the abutment guide 1600 to the maxillary bone reduction guide 1100 in the same manner as the maxillary tooth cap 1200 and the scan bar 1400, and use the abutment guide 1600 to ensure the abutments 1610 have proper angles relative to each other and into the implants 1402 and torque them consistently. Preferably, the amount of torque should be at least 15 Ncm for each implant screw 1610. Then, for digitization, remove the abutment guide 1600. Attach scan bodies 1710 to the scan bar 1300 utilizing threaded inserts 1711 located in scan body posts 1712, and remove the abutments 1610 from the implants 1402 attach scan bodies 1710 to the implants 1402. Attach the scan bar 1300 with the scan bodies 1710 to the maxillary bone reduction guide 1100. Perform a photogrammetry scan. For more accuracy, as shown in FIG. 17D, the surgeon should preferably map the scan bodies 1710 to the closest corresponding maxillary teeth 1304. In an alternative workflow, the scan bodies 1710 may be used in lieu of the intraoral scan with the scan bar 1300 as shown in FIG. 17C

To perform an analog scan of the abutment placement, after torquing the abutments 1610 to at least 15 Ncm, attach soft tissue healing caps 702 on the abutments 1610, reattach the scan bar 1300 to the maxillary bone reduction guide, and scan the maxillary scan bar 1300 and the soft tissue caps 702 in a single scan.

After scanning, attach the maxillary pickup guide 1800 in the same manner as the scan bar 1300, ensuring a full and passive seat, adjusting the intaglio as needed until the pickup guide 1800 is fully and passively seated and can be attached in alignment (in this case using the tabs 1812 with pin apertures 1814. Then the surgeon should manipulate the mandible 301 until centric relation is achieved. Next fill the intaglio 1810 of the device with dental impression material such as PVS and bring the mandible 301 into centric relation with the maxillary arch and hold until the impression material is set. Next remove the maxillary pickup device from the bone reduction guide 1100 and suture the soft tissue of the maxillary arch.

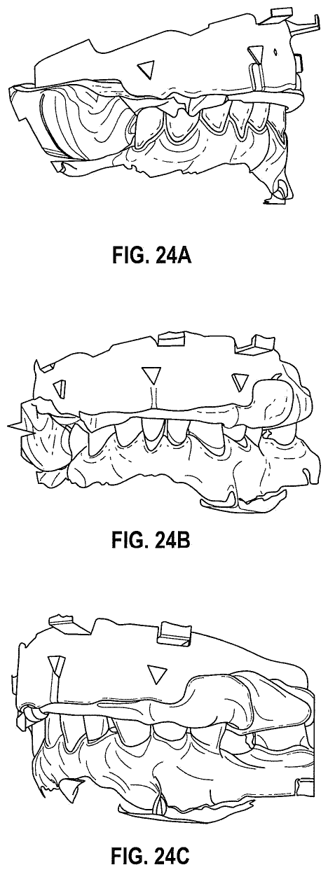

Once the sutures are complete, an impression should be taken of the maxillary arch after suturing, perform an intraoral or desktop scan of the intaglio 1810 and the impression left on the mandibular side of the pickup device, preferably in a single scan. If the maxillary pickup device scan was performed using analog technology, then an intraoral or desktop scan of both arch impressions, including the intaglio and both the maxillary and mandibular facial surfaces of the PGS Finally, for the double arch replacement, this is the point at which the photogrammetry scan of the mandibular arch should be performed, if not done previously before moving to the maxillary arch surgery. Examples of double arch scans in a single scan are shown at FIGS. 24A-24C.

Once all records, including photogrammetry are collected, the entire package of six records should be merged into a single file compatible with 3D printing of the temporary or permanent prostheses using existing 3D printing or material milling technology.

Once the prosthetic(s) are manufactured they can be used by the surgeon for fitting. Due to swelling of soft tissue post-surgery, it is preferably to wait at least 4 months before checking the fit of a new prosthetic. If the patient accepts the provisional prosthesis, then the digital record is accurate, and the patient's digital file is complete, and can be repeated at any point. It is preferable to take a post-recovery soft tissue impression regardless of whether the patient accepts the provisional/temporary prosthesis or not.

If the patient does not accept the provisional prosthetic, then the surgeon preferably uses a supplied centric relation (CR) jig shown in to perform each of the following adjustments:

1. CR Adjustment

The physician installs the CR jig 2500 into the implants of the patient. The CR Jig 2500 is comprised of the same model of the guide device created by the virtual design program, except that for the mandible, it contains only teeth 22-27, and for the maxillary teeth 6-11. The lack of structure posterior to the third tooth from the anterior teeth in either arch allows the surgeon to determine proper centric relation, take an impression with both arches, and the impression and CR jig 2500 are scanned and merged with the patient's existing record to update the centric relation record.

2. Vertical Dimension

Vertical dimension can often be corrected using the CR jig 2500 in the same manner described above with respect to centric relation, but can also be adjusted by using a leaf gauge to determine whether leaves need to be added or removed to determine proper vertical dimension. Once the appropriate vertical dimension is achieve, and impression is taken with the proper leaf and the CR jig 2500 and scanned so that the correct vertical dimension file can be merged with the other critical records.

3. Esthetics

Provided that the centric relation and vertical dimension have been checked and are accurate, esthetics can be corrected, and include issues including, but not limited to midline, incisal position, occlusal plane, tooth shade, tooth mold, gingival shade, gingival anatomy, and arch form. All of these issues can be corrected via a laboratory script available to the patient.

4. Occlusion

As with esthetics, occlusal issues can often be fixed easily, but not until the centric relation and vertical dimension are correct. Once that is done and confirmed, the laboratory script process can be employed to instruct as to what changes need to be made.

5. Implant Position

While rare, especially when using photogrammetry, the solution to improper implant position is usually to rescan the implants using photogrammetry.

6. Soft Tissue

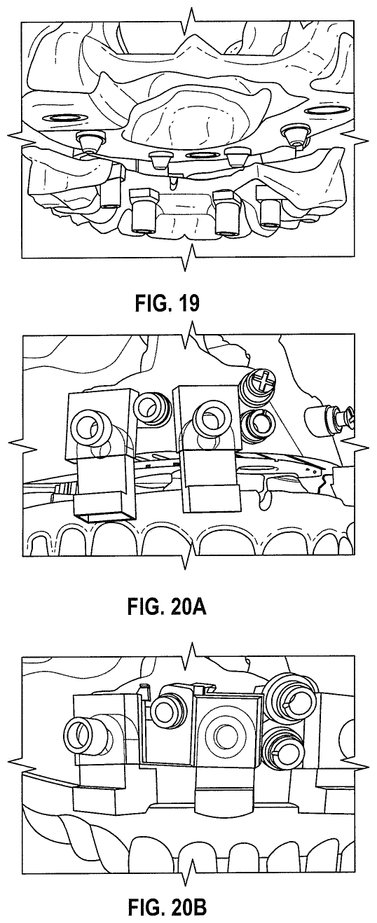

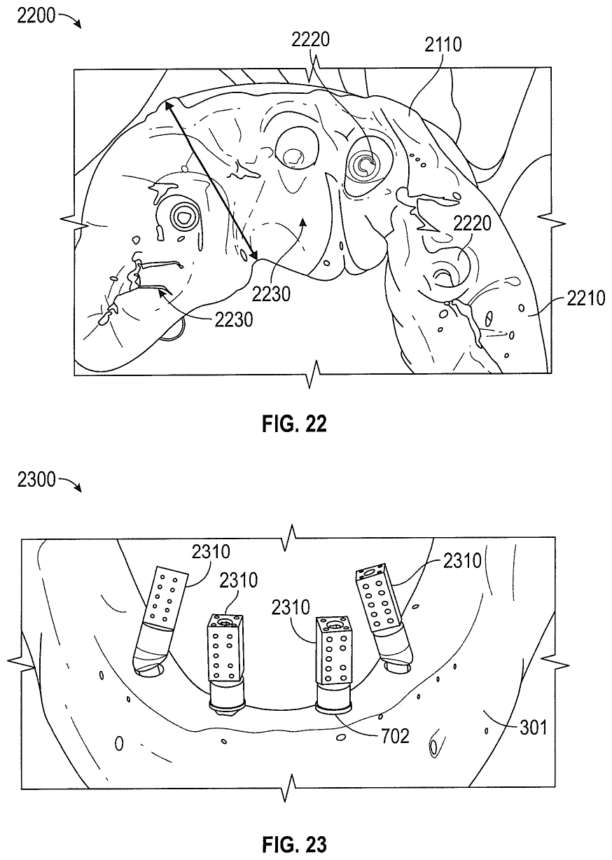

Soft tissue is recommended to be impressed after at least 4 months of recover post-surgery. It can be performed either using analog (impressions) or intraoral scan using the soft tissue healing caps or scan markers used during the pick up step of the process, described above with respect to FIGS. 18-24C.

Principles of the present disclosure can be utilized to facilitate manufacture efficient, repeatable dental prosthetics while minimizing the invasiveness of dental surgery. This disclosure is not limited to the specific embodiments disclosed, but rather encompasses embodiments

The present disclosure offers several advantages:
1. Providing a portable, user-friendly apparatus operable to shear cables in a concrete support system without the use of hydraulics or dedicated batteries;
2. Providing a new use for existing power tools, such as power drills and screwdrivers;
3. Providing a system that can utilize manual or powered torque to accomplish cable shearing;
4. Increasing construction site and tool efficiency by obviating the need for dedicated, powered devices for cable shearing;
5. Converting torque from, for example, a power drill to pressure for cable shearing;
6. Providing a shearing apparatus that can shear a cable using clockwise and/or counter-clockwise torque; and
7. Providing a shearing apparatus that can shear a cable from different directions, such as depending on a braid or weave of the cable.

What is claimed is:

1. A system for creating dental prosthetics, the system comprising:
a bone reduction guide;
a tooth cap operable to connect to the bone reduction guide, wherein the tooth cap is operable to engage one or more teeth of a dental arch to hold the bone reduction guide in place when connected;
at least one implant operable to secure devices to at least one dental arch of a patient;
at least one scan marker operable to be secured to the at least one implant to define a spacial relationship between the implant and the at least one dental arch of the patient;
at least one abutment guide operable to provide a surgeon with a visual representation of a completed dental prosthetic in relation to the at least one implant;
wherein the bone reduction guide is operable to define an area of bone matter for removal to facilitate the placing of the at least one implant in the at least one dental arch, and
wherein the at least one scan marker is operable to provide a reference for use in creating a three dimensional representation of the craniofacial geometry of the at least one arch of the patient.

2. The system of claim 1, wherein the dental arch is the mandibular arch of the patient.

3. The system of claim 2, wherein the completed dental prosthetic is a full mandibular arch prosthetic.

4. The system of claim 1, wherein the bone reduction guide defines the area of bone matter for removal by a guide surface that is adjacent to the bone matter to be removed when the bone reduction guide is fixed to the arch.

5. The system of claim 1, wherein the dental arch is the maxillary arch of the patient.

6. The system of claim 5, wherein the dental prosthetic a full maxillary arch maxillary arch prosthetic.

7. The system of claim 5, wherein the bone reduction guide further comprises at least one hook operable to engage the piriform rim of the patient.

8. The system of claim 5, wherein the bone reduction guide is further operable to be engaged with the piriform rim of the patient while also connected to the tooth cap while the tooth cap is engaged with the one or more teeth of the dental arch.

9. The system of claim 4, wherein the guide surface of bone reduction guide is substantially planar.

10. The system of claim 6, further comprising a scan bar operable to be connected to the bone reduction guide, wherein the scan bar includes analog markers for use in creating a digital representation of the relative location of implants in the maxillary arch of the patient.

11. The system of claim 9, wherein the scan bar further comprises a guide surface substantially contiguous with the guide surface of

12. A method for creating a dental record suitable for producing a dental prosthesis, the method comprising:
collecting a centric relation record;
collecting a vertical dimension record;
collecting a occlusion record;
collecting an esthetic record;
collecting a soft tissue record;
collecting a photogrammetry record operable to show the orientation of one or more dental implants relative to a dental arch in which it is placed, wherein
all collected records are merged into a single record file, and wherein the single record file is operable to provide information necessary print a three dimensional dental prosthesis for the arch.
